(19) United States
(12) Patent Application Publication
(10) Pub. No.: US 2007/0169600 A1
(43) Pub. Date: Jul. 26, 2007

(54) METHOD AND STRUCTURE TO ENABLE FINE GRID MLC TECHNOLOGY

(75) Inventors: Govindarajan Natarajan, Poughkeepsie, NY (US); Michael S. Cranmer, Poughkeepsie, NY (US); James N. Humenik, LaGrangeville, NY (US)

Correspondence Address: LAW OFFICE OF DELIO & PETERSON, LLC., 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 11/307,111

(22) Filed: Jan. 24, 2006

(51) Int. Cl. B26F 1/02; B32B 38/04

(52) U.S. Cl. 83/49; 83/50

(57) ABSTRACT

Methods of forming, and the intermediate substrate products formed, are disclosed whereby a via is formed in the substrate, followed by a second via. The second via is formed such that it overlap the first via, and may remove a first portion of any via distortion residing within the first via. A third via is then formed in the substrate to at least overlap the first via. The third via may remove a second portion of any via distortion within the first via. The second and third vias are formed on opposite sides of the first via, such that the first, second and third vias together form a symmetrically extended via within the substrate. Optionally, a rigid support film may be provided under the substrate prior to forming the extended via.

### BACKGROUND OF THE INVENTION

1. Field of the Invention

The present invention relates to manufacturing of microelectronic components and, more particularly, to punching multiple openings in a ceramic substrate used to produce multi-layer ceramic (MLC) substrates for integrated circuit chips.

2. Description of Related Art

In the ceramic electronics industry, multilayer ceramic (MLC) technology is typically used to create three-dimensional circuitry for microelectronic devices such as integrated circuits and ceramic capacitors. These three-dimensional circuitries are made by applying a conductive material in a circuit pattern on a ceramic/polymer composite sheet known as a greensheet.

Once a greensheet is formed, via holes are formed in a predefined pattern in the greensheet and these via holes are subsequently filled with a conductive paste. Metal lines in a form of circuitry connecting the vias are then formed on the surface of the greensheet by screening or extrusion printing with the conductive paste. A number of via punched metallized greensheets are then stacked in a designated order and laminated together under appropriate heat and pressure to form a laminate that can be handled as a unified structure. The laminated greensheets are then heated in an appropriate atmosphere to form an MLC substrate with complex internal circuitry.

Over the years, future generations of MLC technology have evolved to incorporate advanced technologies and groundrules, i.e., triple dense conductors, thin green sheets and large area greensheets. With these advanced technologies, it is becoming increasingly challenging to increase the circuit density by reducing the via to via pitch and increasing the wiring/line density. Further, as the via diameters and the pitch associated therewith become smaller, it is necessary to use thinner greensheets, and in particular, thinner sheets with large x-y dimensions.

In the course of adopting these new technologies, greensheet stability has become a concern. In particular, the smaller vias and tighter grids pose radial error problems in punching and screening thinner greensheets. These problems include deforming and embossing of the greensheet, misalignment of the conductive vias and other features, as well as partial fills due to trapped air in the vias as a result of filling these smaller vias, all of which typically render the greensheet useless or non-manufacturable.

Further problems associated with punching vias in greensheets are the problems associated with via distortion, such as via breakout. For instance, FIGS. 1 A-B show the results of a conventional approach for punching vias 20 in a thin greensheet 10 having a top surface 17 and a bottom surface 15. In forming these vias 20, a number of punches of a punching tool traverse through the greensheet by entering a top surface 17 and exiting at a bottom surface 15 of the greensheet 10. The punches are then pulled back through the greensheet to form the open vias 20. In so doing, each via is formed with a straight column-like portion 22 with a diameter substantially the same size as the punch diameter, and a flared bottom portion 24 having a diameter at the bottom surface 15 that is substantially larger than the punch diameter. This flared bottom portion 24 is commonly referred to as the via breakout.

With the need to fabricate smaller vias and tighter grids in thinner greensheets, the via breakout is often too large such that it deleteriously reduces the via-to-via spacing. This is undesirable since once the vias are filled with metallurgy, the reduced spacing between vias increases the radial error of the greensheet, which often leads to shorting between adjacent vias.

As it is desirable that future via holes in thinner greensheets be punched and screened with a small radial error, a need continues to exist in the art for improved via characteristics in punched greensheets and methods of making the same.

### SUMMARY OF THE INVENTION

Bearing in mind the problems and deficiencies of the prior art, it is therefore an object of the present invention to provide an improved via-punched and screened greensheet for use with advanced groundrules, thin green sheets, thick green sheets and/or large area greensheets.

It is another object of the present invention to provide an improved greensheet and processing method that reduce deformation and embossing of thin or thick green sheets.

A further object of the invention is to provide an improved greensheet and processing method that reduce radial error of the screened greensheet.

It is yet another object of the present invention to provide a process and system to make greensheet via alignment more precise in stacked greensheet laminates.

Another object of the invention is to provide a processing method of forming a greensheet that utilizes conventional toolset and processes with little or no impact on cost.

Still other objects and advantages of the invention will in part be obvious and will in part be apparent from the specification.

The above and other objects and advantages, which will be apparent to one of skill in the art, are achieved in the present invention, which is directed to in a first aspect a method of forming openings in a substrate. The method includes providing a substrate and forming a first via traversing through the substrate. A second via is then formed in the substrate that overlaps the first via, followed by forming a third via traversing through the substrate. The third via at least overlaps the first via and resides on an opposite side of the first via as compared to the second via. The combination of these first, second and third vias form a single extended via within the substrate.

While the vias may be formed by any known technique, preferably the substrate resides between a punch and a die set for punching the first, second and third vias through the substrate to form the single extended via of the invention. Upon forming the first via, this first via may be plagued by via distortion. In such event, the second via removes a first portion of the via distortion, while the third via removes a second portion of the via distortion residing on an opposite side of the first via. This via distortion may include, but is not limited to, via breakout, debris, substrate distortion, and the like.

Further in this aspect of the invention, the single extended via is preferably a symmetrically formed extended via, and more preferably, comprises an oval via formed in the substrate. The substrate may be any known substrate that requires holes, openings, vias, and the like, to be formed therein, such as, a ceramic layer, a greensheet, a mask layer, a metal layer, an organic layer, an inorganic layer or even composites thereof. Wherein the substrate is a greensheet, the greensheet may be made of alumina, glass ceramic, alumina-magnesia-silicate based ceramics, aluminum nitride, borosilicate glass, polymeric binders, polymers, metal, plastic, oxides of ceramics and glass frit and grit.

Optionally, a rigid support film may be provided on the bottom surface of the substrate to prevent damage to the substrate, as well as to prevent damage to the first, second and third vias during formation of the single extended via. This rigid support film may include a material including, but not limited to, a metal, ceramic, polymer, polyester, polyethylene, polyethylene napthlate (PEN), coated paper (e.g., cellulose based paper or wood product), polypropylene, silicone and combinations thereof. The rigid support film may have a thickness ranging from about 0.5 mils to about 6 mils. In accordance with the invention, a plurality of single extended vias may be formed across the substrate at any angle within an x-y plane of the substrate, vertically within the x-y plane of the substrate, or even horizontally within the x-y plane of the substrate.

In another aspect, the invention is directed to punching openings in a substrate. In this aspect, a substrate is provided and positioned between a punch and a die set. A first via is punched through the substrate, whereby this first via is plagued by via distortion. A second via is then punched through the substrate such that the second via overlaps the first via so as to remove a first portion of the via distortion. Subsequently, a third via is punched through the substrate on an opposite side of the first via as compared to the second via. This third via also overlaps at least the first via, and removes a second portion of the via distortion. Together, the first, second and third vias form a single extended via of the invention within the substrate.

Preferably, the vias are punched symmetrically within the substrate to form a symmetrically extended via. Optionally, a plurality of substrates may be punched simultaneously, whereby the first, second and third vias are simultaneously punching through the plurality of substrates to form a plurality of single extended vias within the plurality of substrates. A rigid support film may be provided under the substrate prior to overlapping via punching in accordance with the invention. The single extended vias may be formed across the substrate at any angle within an x-y plane of the substrate, vertically within the x-y plane, or even horizontally within the x-y plane.

In another aspect, the invention is directed to an intermediate substrate product that includes a substrate having a substantially planar and rigid body. A first via traverses through the substrate body, a second via traverses through the substrate and overlaps the first via, and a third via traverses through the substrate and overlaps at least the first via. The second and third vias reside on opposite sides of the first via, whereby the first, second and third vias together form a single extended via within the substrate.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1A illustrates a top plan view illustrating conventionally punched vias within a substrate.

FIG. 1B illustrates a cross section view showing the conventionally punched vias of FIG. 1A plagued by via distortion.

FIGS. 2A-C illustrate processing steps of the invention for forming an initial via within a substrate that is plagued by via distortion.

FIGS. 2D-F illustrate continued processing steps of the invention for forming a second via in the substrate that overlaps the first via shown in FIG. 2C for removing a first portion of the via distortion.

FIGS. 2G-I illustrate still further processing steps of the invention for forming a third via in the substrate that at least overlaps the first via shown in FIG. 2C for removing a second portion of the via distortion and providing the symmetrically extended vias of the invention having significantly reduced via distortion.

FIGS. 3A-I illustrate a rigid support film being provided between the substrate and the die for providing additional support to the substrate during the present process of overlap punching and forming the symmetrically extended vias of the invention.

FIG. 4 illustrates that a plurality of substrates having rigid support films residing there-between may be overlap punched in accordance with the invention to provide each substrate with the symmetrically extended vias of the invention.

FIG. 5A illustrates a top plane view of a substrate showing the symmetrically extended vias of the invention formed at an angle within the x-y plane of the substrate.

FIG. 5B illustrates a top plane view of a substrate showing the symmetrically extended vias of the invention formed vertically within the x-y plane of the substrate.

FIG. 5C illustrates a top plane view of a substrate showing the symmetrically extended vias of the invention formed horizontally within the x-y plane of the substrate.

FIG. 6A illustrates a top plane view showing a first via punched in a substrate in accordance with the invention.

FIG. 6B illustrates a bottom plane view of FIG. 6A showing the first punched via being plagued by via distortion.

FIG. 7A illustrates a top plane view of FIG. 6A showing a second via punched in the substrate that overlaps the first via.

FIG. 7B illustrates a bottom plane view of FIG. 7A showing that the second punched via removes a portion of the via distortion of the first via.

FIG. 8A illustrates a top plane view of FIG. 7A showing a third via punched in the substrate that at least overlaps the first via, and optionally overlaps the second via.

FIG. 8B illustrates a bottom plane view of FIG. 8A showing that the third punched via removes another portion of the via distortion within the first via.

FIG. 8C illustrates a top plane view of FIG. 8A showing the symmetrically extended via of the invention.

FIG. 8D illustrates a bottom plane view of FIG. 8B showing the symmetrically extended via of the invention, whereby the first via may have an insignificant remaining amount of via distortion that may be useful in detecting use of the present invention.

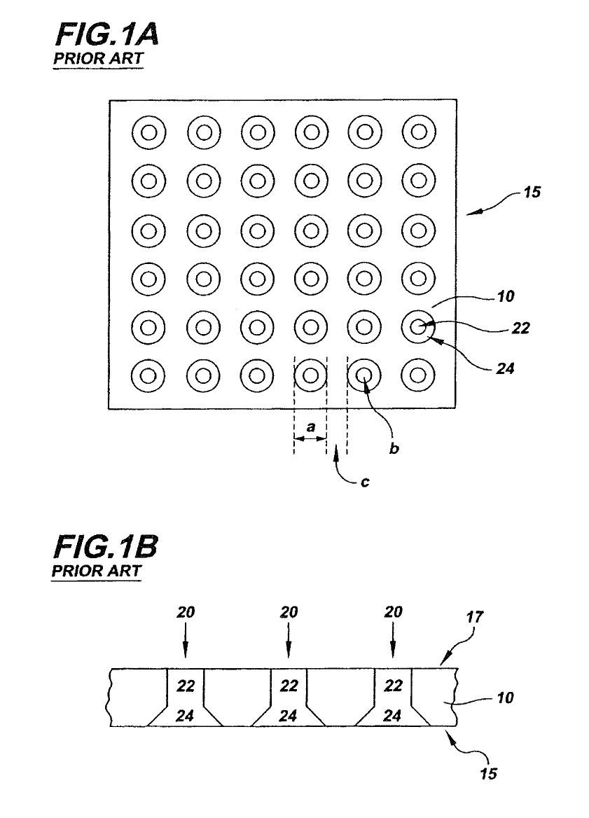

### DESCRIPTION OF THE PREFERRED EMBODIMENT(S)

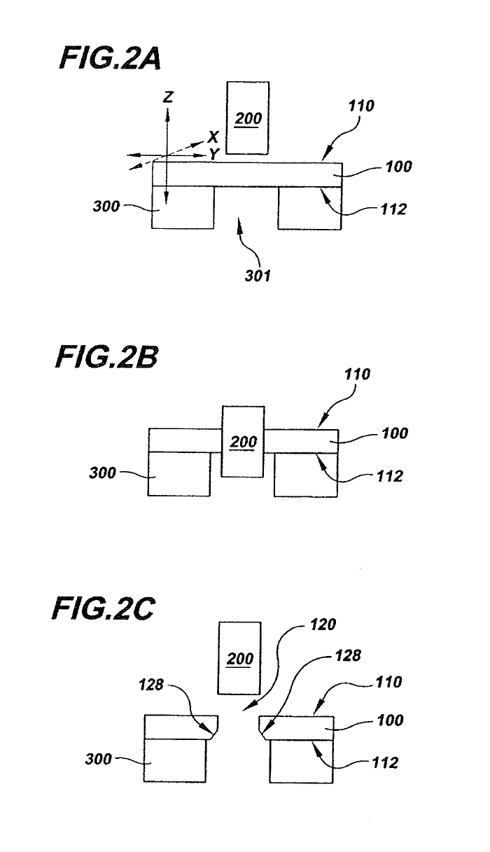

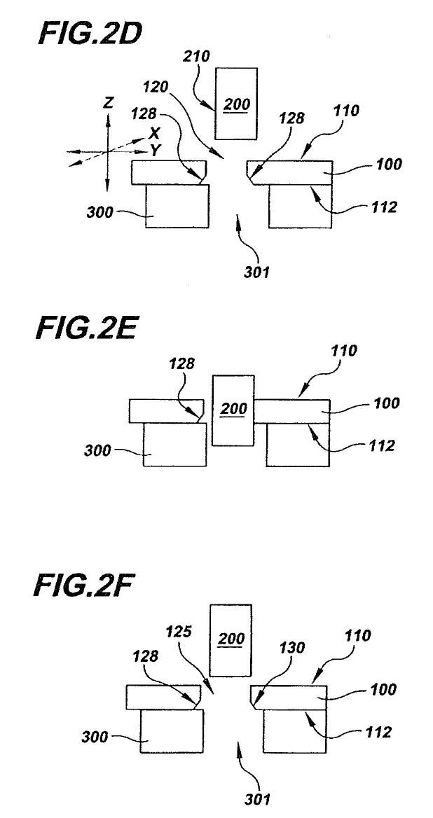

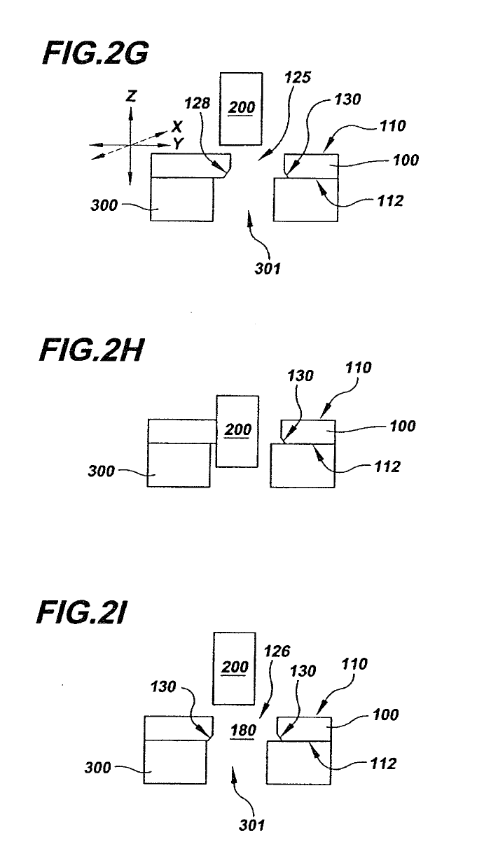

In describing the preferred embodiment of the present invention, reference will be made herein to FIGS. 2A-8D of the drawings in which like numerals refer to like features of the invention.

During the process of punching vias within a substrate, it is common for the resultant vias to be plagued by distortion, due partly resulting from the punch entering from the top surface (embossing effect), partly from the die-set opening to punch clearance (extent of break out), partly from the substrate material characteristics (uneven material movement, tearing, breaking etc), and from material debris trapping commonly at the bottom surface of the substrate where the punch of a punching apparatus is pulled back through the substrate. If the via distortion is not corrected, the resultant substrate may be less useful and valuable since the via-to-via spacing at the substrate bottom (normal side where conductive paste is applied) is significantly reduced due to the via distortion.

The present invention is directed to substantially reducing, or even completely eliminating, any via distortion. This is accomplished by overlap punching a plurality of punches. A preferred embodiment disclosed herein discussed three overlapping punches; however, it should be appreciated that any number of overlapping punches may be employed for sufficiently reducing or entirely eliminating via distortion. It should also be appreciated that while the present invention is discussed in relation to via distortion due to punching vias within a substrate, it is not limited thereto. The present concept of overlapping via formation may be used in conjunction with any known process of forming openings or vias within a substrate, and particular, for those processes and techniques that generate via and/or substrate distortion and deformation. Vias as envisioned by this invention include all shapes including elongated openings like channels.

Referring now to the invention, the preferred punch apparatus includes a punch head assembly that preferably includes a support, a punch head in the support, which is moveable up and down, a means to actuate the punch head and optionally a camera at a fixed position offset to the punch head. The lower part of the punch frame assembly includes a workpiece holder having a vacuum plate for holding a substrate in position and a die set. The workpiece holder preferably moves in the X- and Y-planes, for moving the substrate in such planes, while the die set moves in the Z plane for punching the vias in the substrate.

In accordance with the invention, a substrate 100 is provided that may comprise any known substrate requiring holes, openings or vias to be punched, or re-punched, there-through. The substrate 100 may be used for a number of different uses in a variety of different industries. For instance, the substrate 100 may include, but is not limited to, a ceramic substrate, a greensheet, a mask layer, a metal layer, an organic layer, an inorganic layer and composites thereof. In the preferred embodiment, the substrate 100 is a greensheet, which may be thin, thick, large, composite and combinations thereof. The preferred greensheet has a thickness of less than 6 mils, more preferably ranging from about 1 mil to about 6 mils, and may comprise any known greensheet material including, but not limited to, alumina, glass ceramic, alumina-magnesia-silicate based ceramics, aluminum nitride, borosilicate glass, polymeric binders, polymers, metal, plastic, oxides of ceramics and glass frit and grit.

Referring to FIGS. 2A-C, an initial via 120 is formed in a substrate 100, whereby the invention is suitable for use with fine grid technologies like 150 micron technology, and even technology below 150 microns, such as, between about 125 microns down to about 50 microns, or even smaller (e.g., down to about 25 microns). A punch 200 of a punch head is aligned with an opening 301 in a corresponding die 300 of a die set. The punch is pushed through the substrate 100, whereby the punch 200 enters the top surface 110 of the substrate and exits at the bottom surface 112 thereof. Once the punch 200 has gone through an entire thickness of the substrate, it is pulled back through the substrate 100 to provide the initial opening or via 120 within the substrate. However, this initial via 120 is often plagued by via distortion caused during the punching process. The extent of positional distortion due to embossing is proportional to the clearance between die set opening 301 and the punch size 200, whereby the smaller the clearance, the larger the distortion. Also, referring to FIGS. 2A-I, the bottom portion of via 120 is plagued by via breakout 128 at the bottom side 112 of the substrate, as is shown in FIG. 2C. For fine grid technology, via break out is undesirable since it reduces the much needed critical via to via spacing. Therefore, the challenge is to minimize the die to punch clearance and at the same time eliminate the undesired via distortion.

The present invention alleviates the problems associated with via distortion by significantly reducing the amount of, or substantially eliminating, any via distortion residing within each initially formed via. While reference is made herein to a single via, punch and die, it should be appreciated and understood that a plurality of vias may be formed across the substrate using a plurality of punches in alignment with corresponding die sets.

In accordance with the invention, once the initial via 120 is punched in the substrate, the substrate 100 is moved in a first direction, and then in an opposite direction on the opposite side of the initial via, to maximize the removal of via distortion (e.g., via breakout 128) within via 120. Alternatively, the punch head and die set may be moved and repositioned for reducing the amount of via distortion; however, this approach is less desirable since each time the punch head and die sets are moved, such tools need to be realigned with one another.

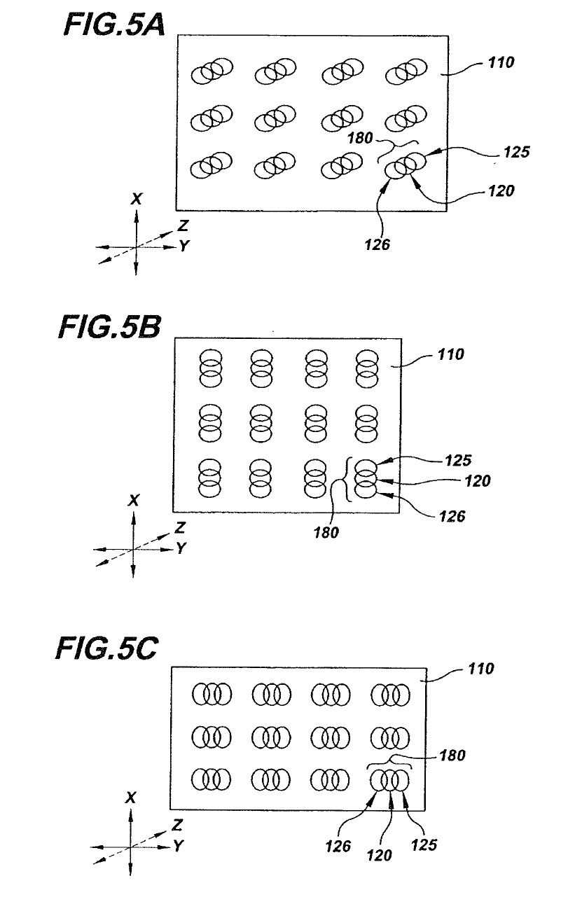

Referring to FIGS. 2D-F and FIGS. 5A-C, wherein the initially formed via is plagued by embossing and via breakout 128 distortions, the removal of this via breakout 128 is maximized by first moving the substrate 100 in the x-plane, y-plane or to any degree within the x-y plane. The substrate 100 may be moved to a distance ranging from about ⅕ to about ½ the distance of the diameter of via 120. In a preferred embodiment, the substrate is moved in the x-y plane to a distance of about ⅓ the diameter of via 120 to form thin straight vias at 45° angles within the substrate x-y plane. For instance, when the substrate is moved about ⅓ the diameter of via 120, an outer edge 210 of punch 200 will then reside over a distance of about ⅔^{rds} the via diameter. In so doing, the punch 200 now resides over portions of both the initial via 120 and the substrate 100 in amounts sufficient to maximize the removal of the embossing along with the via breakout.

After the substrate is moved in the first direction, a portion of embossing and a first portion of via breakout 128 within the substrate 100 resides between the punch 200 and the corresponding aligned opening 301 in the die 300, as is shown in FIG. 2D. This first portion of the embossing and the via breakout 128 is removed by traversing the punch through the corresponding section of substrate 100 (FIG. 2E), in which such first portion of via breakout 128 resides, and then pulling the punch back through the substrate (FIG. 2F). In so doing, the punch 200 simultaneously removes a corresponding first section of substrate 100 and a first portion of via breakout 128 within the initial via to reveal a second punched via 125 that overlaps the initial via 120. This second via 125 have clipped out the embossing and may have an insignificant amount of via breakout 130 that will have inconsequential effects on the resultant product made from substrate 100.

In order to further reduce or eliminate the embossing and the via breakout within the initial via, the substrate 100 is then moved in the opposite direction, to the same distance as that described in relation to FIGS. 2D-F. Referring to FIGS. 2G-21, using the location of via 120 as a starting reference point, the substrate 100 is moved within the same plane, but in the opposite direction, by substantially the same distance as that used to form the overlapping second via 125. Therefore, depending upon the distance the substrate is moved to form via 125, the substrate may be moved by a distance ranging from about ⅕ to about ½ the via 120 diameter on an opposite side of via 120 as that used to form via 125.

A second portion of the substrate residing on an opposite side of the initial via, with its corresponding embossing and the second portion of via breakout 128, now resides between the punch 200 and the aligned opening 301 in die 300. The punch 200 then traverses through the substrate to remove this second portion of substrate along with its corresponding embossing and the second portion of via breakout 128. The punch is pulled back through the substrate to form a third via 126 that overlaps the initial via 120, which may also have an insignificant amount of via breakout 130 that will have inconsequential effects during further processing steps.

As such, the initial or first via 120, second via 125 and third via 126 all reside within the same plane to form an extended via 180, whereby the second and third vias each overlap the first via and reside on opposite sides thereof. This significantly reduces the amount of embossing and via breakout 128 within the initial via 120 by essentially clipping or nibbling away at the embossing and via breakout 128. The extended vias 180 of the invention are preferably symmetrical, and more preferably, comprise oval-shaped vias formed using a circular punch. However, it should be appreciated that any shape punch may be used to form the extended vias 180.

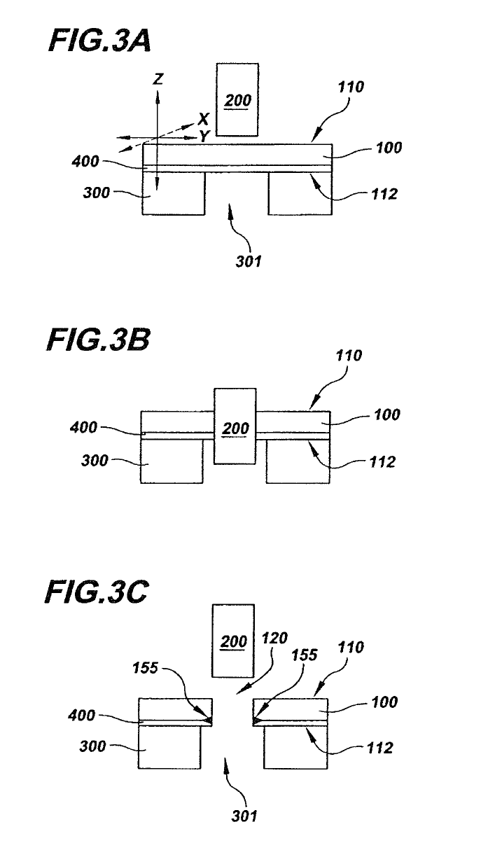

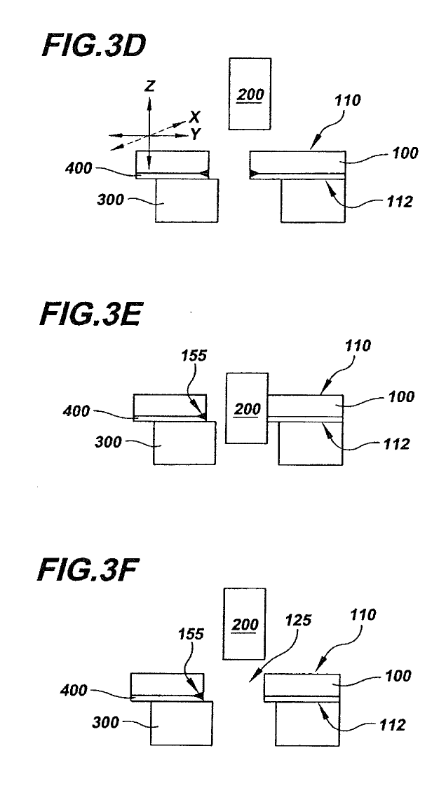

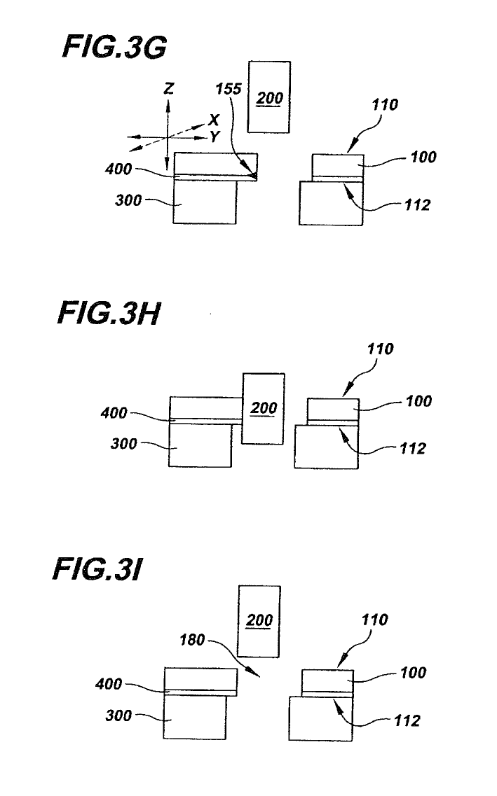

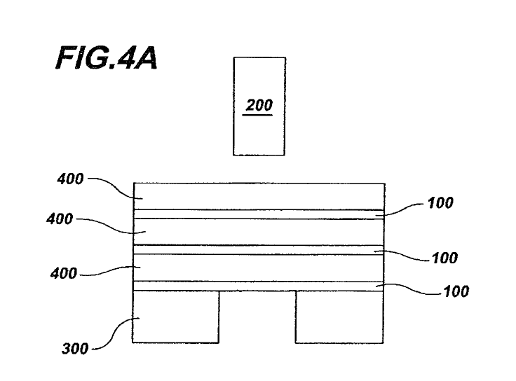

Alternatively, any via distortion within the initially formed via 120 may be substantially eliminated or removed by providing a rigid support film 400 between the substrate 100 and die 300 in combination with the overlapping punching of the invention. Referring to FIGS. 3A-I and FIG. 4A, a rigid support film 400 may be provided at the bottom surface 112 of the substrate 100 (FIGS. 3A-I), or alternatively, a plurality of rigid support films 400 may be provided between a plurality of substrates (FIG. 4A). The plurality of substrates with the plurality of rigid support films may be punched simultaneously using the present overlapping punches of the invention for saving processing time and money, as well as for improving processing efficiency and ease.

In accordance with the invention, the rigid support film 400 preferably has a thickness ranging from about 0.5 mils to about 6 mils, and comprises any suitable material having sufficient rigidity. For instance, the rigid support film 400 may include, but is not limited to, a metal, ceramic, polymer, polyester, polyethylene, polyethylene napthlate (PEN), coated paper (e.g., cellulose based paper or wood product), polypropylene, silicone and combinations thereof.

Each rigid support film 400 is preferably removably attached to a bottom surface of a substrate so that the rigid support film is in direct contact with the die 300. In the case of multiple substrates, a plurality of rigid support films 400 are provided between adjacent substrates to form a stack, whereby the bottom substrate of the stack is provided with a rigid support film (preferably thin moly sheet) for contact with the die 300. Each rigid support film with the stack may be removably attached to the substrates. By directly contacting the rigid support film 400 with the die 300, the substrate is provided with increased strength (and self forming die set) during the process of punching via holes therein, thereby significantly reducing substrate deformation (e.g., distortion, bending, breaking, cracking, and the like). This, in turn, leads to the improvement of radial error and reduces substrate embossing.

Referring to FIGS. 3A-I, using the overlapping punches of the invention, once the rigid support film 400 is provided at the bottom surface 112 of substrate 100, the assembly is positioned between the punch 200 and the aligned hole 301 in die 300. The rigid support film 400 is positioned in contact with the die 300. The punch traverses the substrate 100 and then the rigid film 400, and is pulled back through the rigid film and the substrate to form the initial via 120. As shown in FIG. 3C, during the punching process, the initially formed via may be plagued by via distortion. This via distortion is a result of debris 155 from the punching process (i.e., either substrate or rigid film material) getting trapped between the substrate 100 and rigid film 400 within the initially formed via 120. With the pressure of the punch going through the substrate and film, debris 155 is forced into this region between substrate 100 and film 400 within the via, thereby applying pressure to and hence deforming both the substrate 100 and the film 400. In so doing, the debris may physically distort the via 120 at a bottom of the substrate, the rigid film 400, or even combinations thereof. Alternatively, the only the rigid film may be distorted by the debris 155, such that via distortion is avoided and three overlapping punched vias of the invention will have the same diameter at the top of the substrate and at the bottom of the substrate (i.e., a uniform diameter).

Once the initial via 120 is formed in the substrate 100 and rigid film 400, the substrate and film are moved in the x-plane, y-plane or to any degree within the x-y plane to a distance ranging from about ⅕ to about ½ the distance of the diameter of via 120. The substrate and film now reside between the punch 200 and the aligned opening 301 in die 300 in an amount sufficient to maximize removal of the via distortion (FIG. 3D). The punch 200 traverses these sections of substrate 100 and rigid film 400, and is pulled back there through, to form a second punched via 125 that overlaps the initial via 120 (FIGS. 3E-F). In so doing, the via distortion and embossing, in particular, the trapped debris 155, is removed from this section of the initial via 120.

As shown in FIGS. 3G-I, the substrate 100 and rigid film 400 are then moved in the opposite direction, to the same distance, and within the same plane as that described in relation to FIGS. 3D-F. Second portions of the substrate 100, rigid film 400 and corresponding section of via distortion, all residing on an opposite side of the initial via, now reside between the punch 200 and the aligned opening 301 in die 300. The punch 200 traverses this section of substrate and rigid film to remove the corresponding second portion of via distortion along with these sections of substrate and rigid film. The punch is then pulled back through the substrate 100 and rigid film 400 to reveal a third via 126 that overlaps the initial via 120. Thus, the first via 120, second via 125 and third via 126 all reside within the same plane to form the symmetrically extended via 180 of the invention, which is preferably oval-shaped. Upon completion of the symmetrically extended via 180 of the invention, the rigid support film 400 is then removed or detached from the substrate.

Thus, the overlapping punching of the invention may be performed in the x-y plane to form substantially 45° angled extended vias 180 in the x-y plane (FIG. 5A), in the x-plane to form substantially vertical extended vias 180 in the x-y plane (FIG. 5B), or even in the y-plane to form substantially horizontal extended vias 180 in the x-y plane (FIG. 5C).

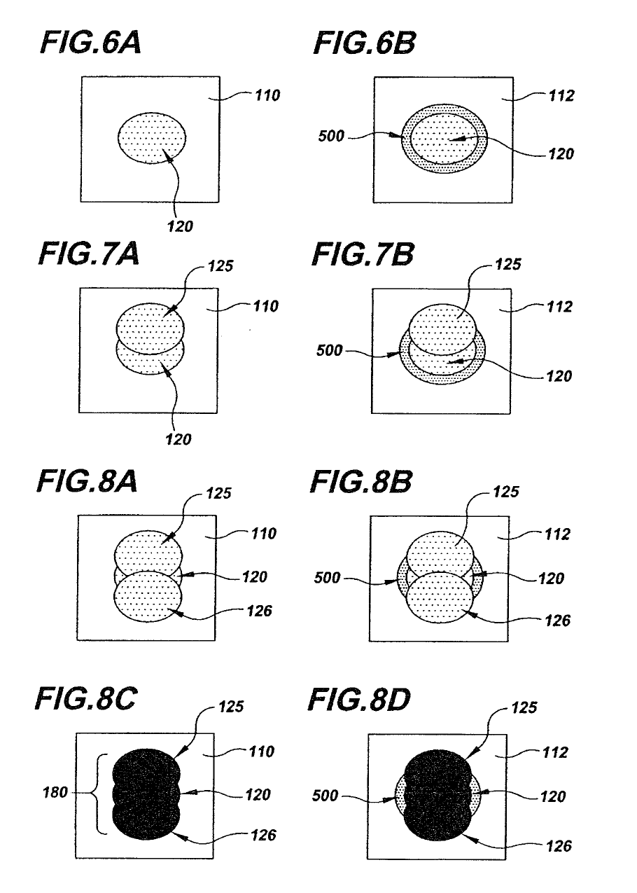

Referring to FIGS. 6A-8D, upon performing the overlapping punching of the invention, the initial via 120 is punched through the substrate, and optionally a rigid film, whereby the size of the via diameter at a top surface 110 of the substrate matches the diameter of the punch used to form such via (FIG. 6A). However, via distortion 500 resides at the bottom surface 112 of the via 120 (FIG. 6B). The invention significantly reduces this via distortion by punching the second via 125 through the substrate and optional rigid film, whereby the via 125 at the top surface of the substrate is substantially the same size as the punch (FIG. 7A). The second via 125 overlaps the first via 120. At the bottom surface of the substrate, this second via 125 reduces the amount of via distortion 500 (FIG. 7B), whereby the second via may have an insignificant amount of via breakout (not shown) that will have inconsequential effects on the resultant product. To further reduce the amount of via distortion 500, the third via 126 is punched through the substrate such that it also overlaps the first via 120 (FIG. 8A). From the bottom surface 112 view of the substrate (FIG. 8B), the third via 126 reduces even more via distortion 500. The three overlapping punched vias of the invention combine together to form a single extended symmetrical via that has the sizes of the overlapping punched vias on the top surface 110 of the substrate (FIG. 8C), and an insignificant amount of via distortion remaining on the bottom surface of the substrate (FIG. 8D). This remaining portion of via distortion is helpful in determining if the present overlapping punching process of the invention is being employed in forming vias within a substrate.

Advantageously, by overlap punching vias to form the symmetrically extended vias 180 of the invention, any via distortion within the originally punched via is substantially eliminated. This process of overlap punching also significantly reduces any substrate embossing, increases the via-to-via spacing, and removes or substantially eliminates via distortion within originally punched vias by punching at least two more vias, both of which overlap the original vias and reside on opposite sides thereof. The symmetrically extended vias of the invention also increase the ease and efficiency of filling such extended vias with metallurgy, as well as significantly reduce the occurrence of any partial fills. By increasing the via-to-via distance, once the extended vias are filled with metallurgy, the increased distance helps prevent the filled vias from coming into contact with each other to prevent shorts, as well as increases space on the substrate for downstream processing (e.g., for forming lines and/or wiring between the extended vias). As such, the invention is advantageous for forming openings down to sizes of about 50-55 microns, or even smaller, for use in denser packages that require increased circuits with lines and wires residing between adjacent vias.

Further, the present process of overlap punching also allows for the reduction of the punch-to-die clearance. In conventional via punching the openings in the die sets must be significantly larger than the punch diameter to prevent embossing of the substrate during the punching process, and ultimately inaccuracy of via placement. For instance, openings in the die set are typically fabricated to about 30 microns larger than the diameter of the punch diameter; for example, wherein the punch diameter is 72 microns the openings in the die set are fabricated to about 102 microns. As such, the clearance between the punch diameter and the die opening is about 30 microns, thereby commonly generating via distortion of about 30 microns in breakout at the bottom of the substrate. Once these conventional vias are filled with metallurgy, the larger via diameter at the bottom of the substrate significantly reduces via-to-via spacing and takes up the valuable real estate on the substrate.

However, since the present invention essentially clips or nibbles away at any via distortion, smaller punch diameters (e.g., punch diameters below about 55 microns, or even below about 25 microns) and dies sets (e.g., die sets having about 20 microns clearance, or even smaller for 25 micron punches) may be employed than those conventionally used in the art. For example, in conventional via punching the punch diameter may be 72 microns with a die set opening of 102 microns, thereby allowing for the punch-to-die clearance of about 30 microns. The vias punched using these dimensions will have via distortion due to breakout up to about 30 microns to provide a via-to-via spacing of about 48 microns. With the present invention of overlap punching to reduce such via distortion, a punch having a diameter of about 56 microns may be used in combination with a die set opening of about 76 microns, thereby providing a punch-to-die clearance of about 20 microns. The via distortion of about 20 microns at the bottom of the first via is then clipped or nibbled away by overlap punching two punches on opposite sides of the first via to provide the narrow extended vias of the invention, which may have a via-to-via spacing of about 74 microns. As such, the smaller punch diameter allows for generating the narrow extended vias of the invention, which take up less real estate on the substrate as compared to conventional single punches having larger punch-to-die clearance (e.g., those having about 30 micron clearance). It should be understood that the present overlap punching invention is also suitable for use with current punch, die and punch-to-die clearance dimensions for reducing or eliminating via distortion.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

What is claimed is:

1. A method of forming openings in a substrate comprising:
providing a substrate;
forming a first via traversing through said substrate;
forming a second via traversing through said substrate and overlapping said first via; and
forming a third via traversing through said substrate and overlapping at least said first via on an opposite side of said first via,
whereby said first, second and third vias together provide a single extended via within said substrate.

2. The method of claim 1 wherein said substrate resides between a punch and a die set, said first, second and third vias being punched through said substrate to form said single extended via.

3. The method of claim 1 further including said first via being plagued by via distortion, whereby said second via removes a first portion of said via distortion and said third via removes a second portion of said via distortion residing on an opposite side of said first via.

4. The method of claim 3 wherein said via distortion is selected from the group consisting of via breakout, debris, substrate distortion, embossing and combinations thereof.

5. The method of claim 1 wherein said single extended via comprises a symmetrically formed via.

6. The method of claim 5 wherein said symmetrically formed via comprises an oval via.

7. The method of claim 1 wherein said substrate is selected from the group consisting of a ceramic layer, a greensheet, a mask layer, a metal layer, an organic layer, an inorganic layer and composites thereof.

8. The method of claim 7 wherein said substrate comprises a greensheet, said greensheet comprising a material selected from the group consisting of alumina, glass ceramic, alumina-magnesia-silicate based ceramics, aluminum nitride, borosilicate glass, polymeric binders, polymers, metal, plastic, oxides of ceramics and glass frit and grit.

9. The method of claim 1 further including, providing a rigid support film on a bottom surface of said substrate to prevent damage to said substrate and said first, second and third vias during formation of said single extended via.

10. The method of claim 9 wherein said rigid support film comprises a material selected from the group consisting of a metal, ceramic, polymer, polyester, polyethylene, polyethylene napthlate (PEN), coated paper (e.g., cellulose based paper or wood product), polypropylene, silicone and combinations thereof.

11. The method of claim 9 wherein said rigid support film has a thickness ranging from about 0.5 mils to about 6 mils.

12. The method of claim 1 wherein said single extended via is formed at an angle within an x-y plane of said substrate.

13. The method of claim 1 wherein said single extended via is formed vertically within an x-y plane of said substrate.

14. The method of claim 1 wherein said single extended via is formed horizontally within an x-y plane of said substrate.

15. A method of forming openings in a substrate comprising:
providing a substrate;
positioning said substrate between a punch and a die set;
punching a first via through said substrate, said first via being plagued by via distortion;
punching a second via through said substrate, said second via overlapping said first via so as to remove a first portion of said via distortion; and
punching a third via through said substrate on an opposite side of said first via as compared to said second via, said third via overlapping at least said first via and removing a second portion of said via distortion,
whereby said first, second and third vias together form a single extended via within said substrate.

16. The method of claim 15 wherein said single extended via comprises a symmetrically formed via.

17. The method of claim 15 further including providing a plurality of substrates, whereby said first, second and third vias are simultaneously punching through said plurality of substrates to form a plurality of single extended vias within said plurality of substrates.

18. The method of claim 15 further including providing a rigid support film on a bottom surface of said substrate to prevent damage to said substrate and said first, second and third vias during formation of said single extended via.

19. The method of claim 15 wherein said single extended via is formed in a direction selected from the group consisting of at any angle within an x-y plane of said substrate, vertically within an x-y plane of said substrate and horizontally within an x-y plane of said substrate.

20. An intermediate substrate product comprising:
a substrate having a substantially planar and rigid body;
a first via traversing through said substrate body;
a second via traversing through said substrate body and overlapping said first via; and
a third via traversing through said substrate body and at least overlapping said first via, said second and third vias residing on opposite sides of said first via,
whereby said first, second and third vias together form a single extended via within said substrate.
